(19) United States
(12) Patent Application Publication
(10) Pub. No.: US 2025/0342532 A1
(43) Pub. Date: Nov. 6, 2025

(54) ASSET MANAGEMENT SYSTEM IN A DISTRIBUTED ASSETS MANAGEMENT PLATFORM

(71) Applicant: Stripe, Inc., South San Francisco, CA (US)

(72) Inventors: Maciej Makowski, Keswick (CA); William Bulovas, Toronto (CA); Sasank Chundi, San Francisco, CA (US); Andrew Straussman, Plymouth, MN (US); Devesh Chourasiya, Mountain View, CA (US); Josh Diaz, Bothell, WA (US); Sumeet Bedi, Kirkland, WA (US)

(21) Appl. No.: 18/654,646

(22) Filed: May 3, 2024

(51) Int. Cl. G06Q 40/06

(52) U.S. Cl. CPC G06Q 40/06

(57) ABSTRACT

Disclosed herein are methods and systems for a memory and network bandwidth efficient processes for managing the movement of assets during distributed services execution by a distributed services system. In one example, an event message is received that specifies configurations of an asset movement. Next, different aggregation processes are performed at different time periods based on the event message configurations, to group and net asset movements to reduce the frequency and number of resulting asset movements, and to enable freeing of distributed services system memory used to store events after aggregation is performed. Next, a planning system of the distributed services system generates a planned action to move assets between accounts based on the aggregation process results. An action executor of the distributed services system executes the planned action causing the movement of the assets.

### CROSS-REFERENCE TO RELATED APPLICATIONS

The present application is related to the following co-pending applications, each of which was filed on Dec. 14, 2023:
U.S. patent application Ser. No. 18/540,626, titled “Distributed Assets Management Platform”;
U.S. patent application Ser. No. 18/540,633, titled “Assets Interface of a Distributed Assets Management Platform”;
U.S. patent application Ser. No. 18/540,630, titled “Hydration System In a Distributed Assets Management Platform”;
U.S. patent application Ser. No. 18/540,638, titled “Exchange Platform In A Distributed Assets Management Platform”;
U.S. patent application Ser. No. 18/540,634, titled “Machine-Learning Based Delay Prediction”; and
U.S. patent application Ser. No. 18/540,619, titled “Data Aggregation for Thresholding-Based Account Management”.

Each of the above applications are incorporated by reference herein in their entirety for any purpose.

### BACKGROUND

Modern distributed computing systems typically provide a number of services to their users, where each service may have its own execution. In such a distributed computing system, the services operate independently of one another, as well as interact with one another, to enable each of the various services offerings of the distributed computing system. The execution of the services may have an impact on assets managed by the distributed computing system. In some examples, the distributed computing system may maintain hundreds of accounts for different service and/or entities (e.g., legal, juristic, or other divisions of the distributed computing system) distributed among a plurality of real-world locations and/or logical locations. Then, execution of the services at scale, such as millions to billions of service operations each day, creates several significant computational problems, including the complexity of managing the movement of assets in response to the service operations executed by the various, distributed, and independently operating services, consumption of a large amount of hardware storage resources while storing and managing movement of the assets, and consumption of communications bandwidth in a computer network. These computing problems are exacerbated in a distributed computer system that operates at scale and is therefore a computationally complex problem that needs to be addressed.

### SUMMARY

Example methods are disclosed herein. An example method for a distributed services system providing asset management during distributed services execution includes: receiving, by an asset management system, an event message that defines a target amount change associated with a first account, an actual amount change associated with the first account, and an identifier of a segment of the event message; generating, by an aggregator of the asset management system for a first period of time, a net target amount change associated with the first account and a net actual amount change associated with the first account from a plurality of event messages having the identifier of the segment, the plurality of event messages comprising the event message, and the net target amount change generated based in part on the target amount change and the net actual amount change generated based in part on the actual amount change of the event message; generating, by the aggregator of the asset management system based on the net target amount change associated with the first account and the net actual amount change associated with the first account, a total target amount change associated with the first account and a total actual amount change associated with the first account for a second period of time; generating, by a planning system of the asset management platform, an action that will move an amount between the first account and a second account based on the total actual amount change generated by the aggregator; and executing, by an action executor of the asset management platform, the action causing movement of the total target amount change associated with the first account.

Example systems that execute, and non-transitory machine readable media having instructions stored thereon, which when executed by a processing system, causes the processing system to perform operations for, the above discussed method are also disclosed herein.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 is a block diagram of an exemplary system architecture of a commerce platform that performs asset management for distributed services.

FIG. 2 illustrates a block diagram of one embodiment of a distributed assets management platform for performing asset management for a commerce platform.

FIG. 3 illustrates a flow diagram of one embodiment of a process for performing asset management by an asset management system.

FIG. 4 is a block diagram of an asset management system of a distributed assets management platform.

FIG. 5 is a diagram of one embodiment of a process performed by an asset management system for performing sets of aggregation operations.

FIG. 6 is a diagram of one embodiment of a process performed by an asset management system for attributing asset movements to event messages.

FIG. 7 is one embodiment of a computer system that may be used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “generating”, “executing”, “aggregating”, “modifying”, “storing”, “locating”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

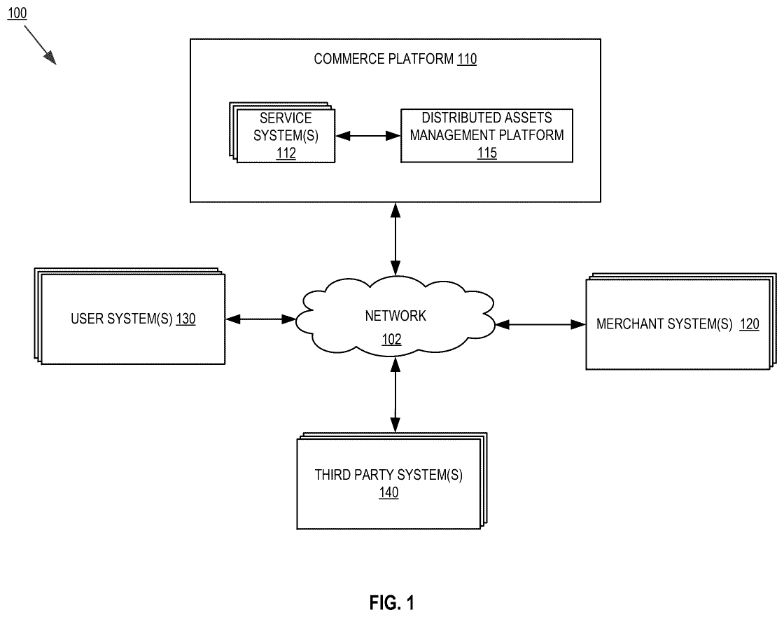

FIG. 1 is a block diagram of an exemplary system architecture of a commerce platform that performs asset management for distributed services. In one embodiment, the system 100 includes commerce platform 110, one or more merchant system(s) 120, one or more user system(s) 130, and one or more third party system(s) 140 (e.g., regulatory systems, banking systems, card network systems, authentication systems, foreign exchange trading systems, etc.). In one embodiment, one or more systems (e.g., system 120, 130, and 140) may be computer systems, such as a desktop computer system, laptop computer system, server computer systems, etc. The commerce platform 110, merchant system(s) 120, and third party system(s) 140 may also be one or more computing devices, such as one or more server computer systems, desktop computer systems, etc.

The embodiments discussed herein may be utilized by a plurality of different types of systems, such as other commerce platform(s) including payment processing systems, card authorization systems, banks, and other systems seeking to manage asset movements using a distributed and extensible computing architecture, as discussed herein. Furthermore, any system seeking to manage asset movements may utilize the techniques discussed herein. However, to avoid obscuring the embodiments discussed herein, the management of asset movements is discussed in terms of an example commerce platform to illustrate and describe the embodiments of the present invention, and is not intended to limit the application of the techniques described herein to other systems.

The commerce platform 110, merchant system(s) 120, user system(s) 130, and third party system(s) 140 may be coupled to a network 102 and communicate with one another using any of the standard protocols for the exchange of information, including secure communication protocols. In one embodiment, one or more of the commerce platform 110, merchant system(s) 120, user system(s) 130, and third party system(s) 140 may run on one Local Area Network (LAN) and may be incorporated into the same physical or logical system, or different physical or logical systems. Alternatively, the commerce platform 110, merchant system(s) 120, user system(s) 130, and third party system(s) 140 may reside on different LANs, wide area networks, cellular telephone networks, etc. that may be coupled together via the Internet but separated by firewalls, routers, and/or other network devices. In one embodiment, commerce platform 110 may reside on a single server, or be distributed among different servers, coupled to other devices via a public network (e.g., the Internet) or a private network (e.g., LAN). It should be noted that various other network configurations can be used including hosted configurations, distributed configurations, centralized configurations, etc.

In one embodiment, commerce platform 110 provides financial processing services to one or more merchants, such as to merchant system(s) 120 and/or user system(s) 130. In some examples, commerce platform 110 may manage merchant accounts held at the commerce platform, run financial transactions from user system 130 performed on behalf of a merchant system, clear transactions with third party systems 140 (e.g., credit card systems, banking systems, payment service systems, etc.), perform payouts to merchant and/or merchant agents, manage merchant and/or agent accounts held at the commerce platform 110, manage transfers between accounts established for different merchant system 120, perform tax tracking and regulatory compliance services for one or more of the merchant system 120, one or more user system(s) 130, and/or one or more service system(s) 112 as well as other services typically associated with commerce platforms systems.

In embodiments, commerce platform 110 therefore includes a plurality of service system(s) 112 that independently and collaboratively provide the various services of the commerce platform discussed herein to merchant system(s) 120, user system(s) 130, and third party system(s) 140, as well as to other service system(s) 112. That is, each service system 112 may not only support the services offered to external systems (e.g., user system(s) 130, merchant system(s) 120, and/or third party system(s) 140), but may also aid and contribute to the execution of other service system(s) 112. Each of the service system(s) 112 is a distributed service system, such that one or more instances of each service system may be executed by distributed computing resources of the commerce platform 110. In some examples, the service systems are systems that execute payment processing services, subscription services, digital wallet services, regulatory compliance services, fraud detection services, as well as other services associated with commerce platforms, such as commerce platform 110.

In embodiments, each of the service system(s) 110 in executing their respective services therefore generates what is collectively referred to herein as event messages communicated from a service system to distributed assets management platform 115. An event message, as discussed in greater detail herein is an electronic message that defines various asset movement implications, such as a nature of a transaction sought to be processed by a service system, one or more event message identifiers that will identify one or more asset movements associated with the event, account identification information (e.g., source and destination accounts of asset movement that will be caused by the event), asset movement implication information (e.g., data describing account credits, account debits, as well as other information including currencies involved), timing information (e.g., information describing when assets should move between accounts), as well as other information. The plurality of service system(s) 112 that continuously process transactions for the commerce platform 110 therefore generate a stream of event messages sent to the distributed assets management platform 115.

Distributed assets management platform 115 is responsible for performing real time asset management for the events generated by the service system(s) 112. That is, each of the service system(s) 112 perform their respective operations generating a stream of independent events having different asset movement implications for the various accounts maintained by the commerce platform 110. Then, distributed assets management platform 115, as discussed in greater detail below, includes distributed systems and platforms that collectively manage in house assets of the commerce platform 110. As discussed herein, the commerce platform 110 has a number of accounts (e.g., on the order of hundreds or more) that are geographically distributed around the world and/or associated with different entities of the commerce platform 110, the events generated by the service systems 112 cause each of those accounts to have inflows (payments in from other accounts of the commerce platform, as well as payment in from external systems such as banking systems, credit card systems, digital wallet systems, etc.) and outflows (payments out to other commerce platform accounts, as well as payments to external systems such as banking systems, credit card systems, digital wallet systems, etc.), and potentially involving different currencies between source and destination accounts. In embodiments, an entity is a division of the commerce platform 110, such as a juristic entity, a geographic entity, a legal entity, a service system based entity, etc.

Ultimately then, there are times when an asset is to move between accounts to ensure, in some examples, there are sufficient asset totals to support an asset movement (e.g., an account has a sufficient balance to support an outflow, a potential currency volume will support transaction loads, etc.). In other words, and as discussed in greater detail herein, distributed assets management platform 115 is responsible for ensuring account liquidity so that assets are where they needs to be at the correct time to support the service system(s) 112 (e.g., a service system does not debit an account with a negative balance or insufficient asset totals), and also to minimize and manage exchange exposure (e.g., ensuring a US based entity does not have an unacceptable level of Euros in its accounts). Therefore, in some examples, distributed assets management platform 115 processes service system events (e.g., a charge happened, a refund happened, a dispute happened, etc.) as a stream of event messages, converts each event message to an assets management platform message indicative of an asset movement impact (e.g., inflows, outflows, accounts, timing, foreign exchange implications, one or more identifiers including a segment identifier, etc.), and then manages the asset movement impact within accounts of the commerce platform 110 in response to the events. The management of assets by the distributed assets management platform 115 involves, in some examples, generating asset movement operations that move assets between accounts to ensure the multitude of commerce platform 110 accounts have sufficient assets when they need it.

Furthermore, given the fluctuating nature of system load on asset movements (e.g., increased event messaging related to transactions as a result of holidays in specific geographic regions, increase in merchant traffic, regular cyclic activity such as increase transaction load during weekends, etc.), distributed assets management platform 115 utilizes a distributed architecture of communicatively coupled systems and platforms that flexibly and with independence collectively perform asset movement operations and exchanges to ensure each account and thus service system has sufficient assets at the correct time. Furthermore, the distributed nature of the architecture of the distributed assets management platform 115 enables system and/or platform reuse, such as dynamic instance generation and taking down to dynamically respond to system load placed on the service system(s) 112, and thus the distributed assets management platform 115, of the commerce platform 110.

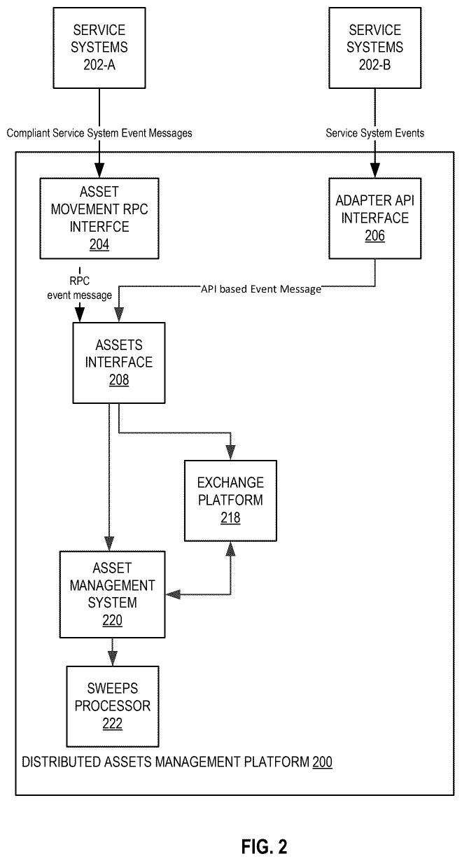

FIG. 2 illustrates a block diagram of one embodiment of a distributed assets management platform 200 for performing asset management for a commerce platform. The distributed assets management platform 200 provides additional details for the distributed assets management platform 115 discussed above in FIG. 1.

The distributed assets management platform 200 includes a plurality of systems and platforms, the operations of which are discussed in greater detail below. Each of the plurality of systems and platforms are executable on distributed processing resources of a commerce platform, and represent instances of each such system and/or platform. Thus, in some examples, one or more of the plurality of systems and platforms may spawn new instance(s) to account for increased system load and/or take down instance(s) in response to decreased system load. Therefore, the operations discussed below are those of a given instance of the corresponding systems and platforms.

Furthermore, as discussed above, distributed assets management platform 200 is responsible for managing the asset movement implications generated by the service system(s) 202-A and 202-B. The service system(s) 202-A and 202-B are those illustrated and described above in FIG. 1 (e.g., service system(s) 112), and generate various event messages in response to product and/or transaction operations generated by the service system(s) 202-A and 202-B, which may be referred to as product level events or service system events.

The service system 202-A is a service system that is integrated with distributed assets management platform 200, as indicated by the stream of compliant service system event messaging sent to cash flow remote procedure call (RPC) interface 204. In embodiments, the assets interface 208 defines a standard format for distributed assets management platform 200 event messaging which includes all relevant fields of information sufficient to invoke a workflow to manage a movement of assets. Thus, the service system 202-A is a service system capable of generating event messages that comply with the format, structure, and content definitions of the assets interface 208. Thus, compliant service system event messages may be streamed as remote procedure call (RPC) event messages via an application programming interface endpoint, such as asset movement RPC interface 204. RPC interface 204 is a network addressable location where the service system 202-A can address event messages for entry into the distributed assets management platform 200, and serves to forward event messages to the assets interface 208. The content and formatting, as discussed in greater detail herein includes an event identifier (e.g., a unique identifier generated for each event by a service system generating the event), source and destination account identifiers, timing information (e.g., timestamps indicating when assets can depart a source and when assets should be available at a destination), and an amount associated with the event (e.g., a debit amount from a source account specifying a currency, and a credit amount at the destination account specifying the same or different currency). The RPC interface 204 then transmits an API based remote procedure call to an API messaging endpoint exposed by the assets interface 208 to validate the service/product event message and insert the message into the asset management processes of the distributed assets management platform 200.

In some embodiments, distributed assets management platform 200 may work with alternative service systems such as the service system 202-B that are not integrated with distributed assets management platform 200. In this alternative setup, the stream of event messages sent from second service system 202-B is sent to the adapter API interface 206. The second stream of event messaging includes event messages that include incomplete data and/or incorrect formatting. The adapter API interface 206, similar to RPC interface 204, is also a network addressable location, but is configured to receive a second stream of event messages from the non-integrated service system 202-B, so that the adapter API interface 206 can transform each of the second stream of event messages into compliant event messages. In some embodiments, the second event messages include an event identifier (e.g., generated by a service system to uniquely identify the event), but does not specify source and/or destination accounts for an asset movement, as is specified in the compliance event messages. Thus, in some examples, the adapter API interface 206 uses the event identifier to perform one or more lookups with the service system that generated the event message, other service system(s) (not shown) that process portions of a transaction related to the event, a database (not shown) of accounts associated with service systems or entities for which the service system is performing operations, etc. to determine the source and destination account information for an event message, as well as timing information specifying funds availability. In some examples, the event identifier may be used to query service system(s) (e.g., charge service systems, accounting service systems, credit card processing service system(s), etc.) to determine which accounts are relevant to an event/transaction, and in some examples timing constraints imposed on the event/transaction by such service system(s). In response to obtaining sufficient data to generate a compliant event message, the adapter API interface 206 generates an API message having the requisite information, identifiers, and timing information, and transmits the API message to the API endpoint exposed by the assets interface 208. In some examples, the API messages generated by API interface 206 are compliant messages as a result of the adapter API interface 206 updating the message to include the requisite information, identifiers, and timing information expected by assets interface 208. The API based messages are used for validation of event messages and insertion of the event messages into the asset management processes of the distributed assets management platform 200.

The assets interface 208 is responsible for receiving the streams of API based RPC event messages and API messages from the cash flow RPC interface 204 and the adapter API interface 206. These event messages are collectively referred to herein as asset interface event messages, and in some examples event messages. In response to receipt of each asset interface event message, the assets interface 208 first verifies whether an asset interface event message is permissible or able to be processed. That is, an asset interface event message may specify events associated with sanctioned countries, violate regulatory compliance requirements, exceed commerce platform controls, etc. Thus, the assets interface 208 may reject an asset interface event message when the data defined in the asset interface event message violates any of the feasibility or permissibility constraints on allowable asset movement events. When rejected, a notification is generated and transmitted to the originating service system and/or other service systems as to the event/transaction that violated one or more feasibility checks. However, when determined to be permissible, the assets interface 208 generates a signature (e.g., a hash or other cryptographic identifier form the content of the event message, such as a concatenation of various fields) so that the signature can be later regenerated to determine that no information (e.g., original source and destination accounts, amounts, timing information, etc.) has been changed. Event message permissibility or feasibility analysis is discussed in greater detail below.

Returning to assets interface 208, which receives asset interface event messages from RPC interface 204 and API adapter interface 206, in some examples, the assets interface 208 may modify certain asset interface event information, such as splitting an asset movement (e.g., a primary asset movement specified in an asset interface event message, a fee amount, a credit card agency fee amount, etc.) into a plurality of constituent or related asset movements. Furthermore, an asset movement may be altered to resolve a non-feasibility or impermissible detection when an impermissible asset movement is transformed into a permissible asset movement when an original route for the movement is split into multiple asset movement routes. Such leg splitting enables the assets interface 208 to improve and increase event messaging throughput and processing by enabling asset implication management for otherwise impermissible events. In some examples, feasibility analysis performed by the assets interface 208 can detect that an asset movement from acct_A to acct_B is impermissible (e.g., because such a movement would violate commerce platform policy, a regulation, involves a transfer between incompatible accounts, etc.). However, acct_A can be determined as permissible to move assets to acct_X, and acct_X can be determined as permissible to move assets to acct_B. Thus, the asset interface event message may be altered by the assets interface 208 so that the event message includes more internal movement legs to enable an assets movement and/or is split into a set of asset movement events. Note that feasibility may not be the only condition that is used for adding/modifying asset movement legs of an asset movement. In some examples, preferred movements to and/or through predetermined accounts, tax benefit based movements that will minimize tax implications of associated accounts, preferred account status, etc. may inform and/or enable alteration of an initial asset movement to two or more asset movements.

In some examples, assets interface 208 further modifies each asset interface event message by adding a segment identifier. In embodiments, the segment identifier is generated from data passed into the distributed assets management platform 200 as part of a service system 202 request, and encodes information, such as one or more of a name of the upstream system generating the request, asset movement configurations including type of asset movement, infrastructure or system facilitating a movement, one or more entities involved with an asset movement, etc. As will be discussed in greater detail below, a segment identifier enables grouping of certain asset movements together for analysis by the asset management system 220. In embodiments, assets interface 208 maintains a table, listing, or other data structure that identifies, for example based on a service system identifier, source account, destination account, etc. in an asset interface event message, an asset movement type, or other identification data, and the segments that are mapped to the selected information data field extracted from each asset interface event message.

The asset interface event message, with the segment identifier, account identifiers, data indicating the asset exchange (e.g., a target Amount change associated with the identified accounts, and an actual amount change associated with the identified accounts), as well as other data, is transformed into an asset management event message, and forwarded to asset management system 220 and optionally exchange platform 218.

The asset management platform 220, in embodiments, exposes an API endpoint for receiving asset management event messages from assets interface 208 and optionally from exchange platform 218. The API endpoint is configured to receive asset management event messages as remote procedure calls (RPC). The asset management event message RPCs therefore form a stream of asset management event messages with asset movement implications, where asset management system 220 is responsible for executing the appropriate asset movements at the appropriate times to ensure sufficient liquidity of accounts of the commerce platform to meet immediate and future obligations, such as ensuring sufficient assets in accounts at the appropriate times for withdrawals, refunds, top-ups, scheduled transfers, etc. In some examples, the asset management system 220 collects asset movements (e.g., from the asset interface event message stream of the assets interface 208 and/or exchange platform 218) and schedules transfers.

In some examples, the asset management system 220 represents asset movements as targets and balances, rather than credits and debits. A target asset movement is an amount associated with the movement, and a balance is the amount change in a target account. In some examples, a target is therefore a desired liquidity of an account based on the amount change, and balances represent a current account balance adjusted by amount change in the target account. In embodiments, and as discussed in greater detail herein, the asset management event messages stream is processed by the asset management system 220 into one or more planned asset movements in a processing, memory, and network bandwidth efficient manner.

In embodiments, the asset management event messages stream received by asset management system 220 is parsed into segments by segment identifier. Segments, as discussed herein, are related asset movements and the asset movements in a segment can ultimately be netted against one another. For example, segments may be related based on service, type of asset movement, accounts associated with an asset movement, timing of an asset movement, etc. Furthermore, segments identifiers added to asset interface event messages, as discussed herein, are configurable so that the segmentation of asset interface event messages can change based on a current segment identifier mapping.

In embodiments, once segmented, asset management system 220 performs a first set of aggregation operations for the asset management event messages per segment identifier. The first set of aggregation operations enable the asset interface event messages of each segment to be combined with one another (e.g., if asset interface event message X requests a balance change of $100, and asset interface event message Y request a balance change of −$100, then aggregation can net those two requested balance changes to $0). The first set of aggregation operations are performed over a first periodic interval (e.g., one minute, two minute, five minute period of time) creating a total movement of assets for each segment identifier. In some examples, the movement of assets can be referred to as a bucket over the first time period per segment. In some embodiments, once an asset management event message is aggregated into its segment bucket for a given period of time, it can be deleted. That is, the asset management event messages are not persisted by asset management system 220 to reduce an overall memory consumption of the asset management system 220. Such reduced memory consumption enabled, via the first set of aggregation operations, free a significant amount of system memory for systems that operate at sale, such as the commerce platform discussed herein.

In embodiments, asset management system 220 then performs a second set of aggregation operations on segment buckets. In embodiments, the segment buckets aggregate by segment identifier over a first periodic interval are accumulated over a successive number of first periodic intervals. Then, at a second periodic interval, greater than the first periodic interval, the segment buckets may be aggregated to further combine asset movements within each of the segment buckets against each other. For example, whereas the first periodic interval may result in the generation of five minute segment buckets, and the second periodic interval may result in the generation of a fifteen minute segment asset movement result per segment identifier. Similar to the above discussion, once aggregated at the second periodic interval, the memory associated with the segment buckets generated over the successive first periodic intervals may be freed, again reducing memory utilization by the asset management system 220 and freeing the memory for other uses.

In embodiments, asset management system 220 performs the further second set of aggregation operations (e.g., on segment buckets) to increase the reach of netting the results of the segment groups. That is, by combining more asset management event messages in the first set of segment buckets and then the second aggregation, the total overall asset movements can be reduced by allowing an increased number of asset movements within segments to net against one another. Beneficially, because the resulting asset movements are communicated to sweeps processor 222 to execute the asset movements, sweeps processor may perform the netting and generate a reduced number of asset movements for communication to and/or execution by an system that performs asset movements (e.g., executor 432 discussed below). By reducing the number of asset movements that are communicated, scheduled, and/or executed, bandwidth consumption can be greatly reduced as a result of the aggregation operations and netting performed by the asset management system 220, by reducing the overall number of event messages generated and transmitted to carry out asset movements.

Asset management system 220 generates the requested asset movements (e.g., those that exist after aggregation and netting by segment), by specifying accounts affected by a netted target and balance change including timing information associated with a required transfer time. Sweeps are planned and executed by the sweeps processor 222 based on the requested target, and further in view of the timing constraints, to perform asset movements to manage account liquidity in a just-in-time fashion. That is, further netting can be performed by delaying asset movements until a last possible time when a movement can be performed, wherein the last possible time is determined by sweeps processor based on the timing constraints associated with asset movements, as well as known timing constraints such as time-in-flight data associated with certain types of asset movements, accounts, etc. Such additional netting further reduces processing and memory utilization by avoiding oscillation of account balances. In some examples, transfers that occur too early may suffer from not being netted against other transactions, resulting in asset movements that, for example, increase and then decrease the same account's balance over two requested asset movements. However, if netted against one another based on timing constraints, a single or perhaps no asset movements are executed, thereby reducing the number of requested asset movements generated and/or communicated between the asset management system 220 and the sweeps processor 222 that merely move assets back and forth between the same accounts. Rather an increased amount of netting can occur until a last moment while still satisfying liquidity of accounts.

Furthermore, the asset movements caused by asset management system 220 can include detecting float usage by upstream services. Float usage is a scenario where assets exist simultaneously in two accounts at the same time when a debit moves assets from an account, and the increased liquidity may cause float based on timing of the asset movements. In some examples, the asset management system 220 detects float, and attributes the float to upstream services causing the float, for example, based on service identifiers associated with certain asset movements, unique identifiers that are assigned to individual asset movements, or other identifiers. Float detection can be communicated to the service causing float in the event float is not intended.

Sweeps processor 222, which in some examples is integrated into the asset management system 220, collects the asset management event messages from asset management system 220 and executes asset movements (e.g., physically moves assets between accounts) at periodic intervals (e.g., every minute, hour, day, etc.) to ensure sufficient liquidity within the accounts of the commerce platform 110. In embodiments, sweeps processor 222 includes a planning system that is preconfigured with routes between accounts of the commerce platform (e.g., for segment, a route of acct_A→acct_B is allowed, a route of acct_B→acct_C is allowed, but a direct route acct_A→acct_C is not allowed), as well as constraints defining allowed movements (e.g., a segment cannot move assets to an account maintained in country X, a movement is not allowed that would decrease a balance below a threshold, etc.). Therefore, sweeps processor 222 uses the preconfigured routes and constraints to plan and execute asset movements, including netting any asset movements having the same accounts. Furthermore, in embodiments, an event indicating satisfaction or completion of an asset movement is emitted by sweeps processor 222, for consumption by an attribution system discussed in greater detail below.

In embodiments, the asset management system 220 is therefore able to greatly improve the processing, memory, and bandwidth utilization of the asset management system 220, and thus the underlying distributed assets management platform 200. Such efficiency gains become significant to the hardware resources utilized by the distributed assets management platform 200 at the scale of modern commerce platforms and/or other digital platforms that can utilize the techniques set forth herein. A further discussion of the operations of an asset management system that provides for asset management is set forth below.

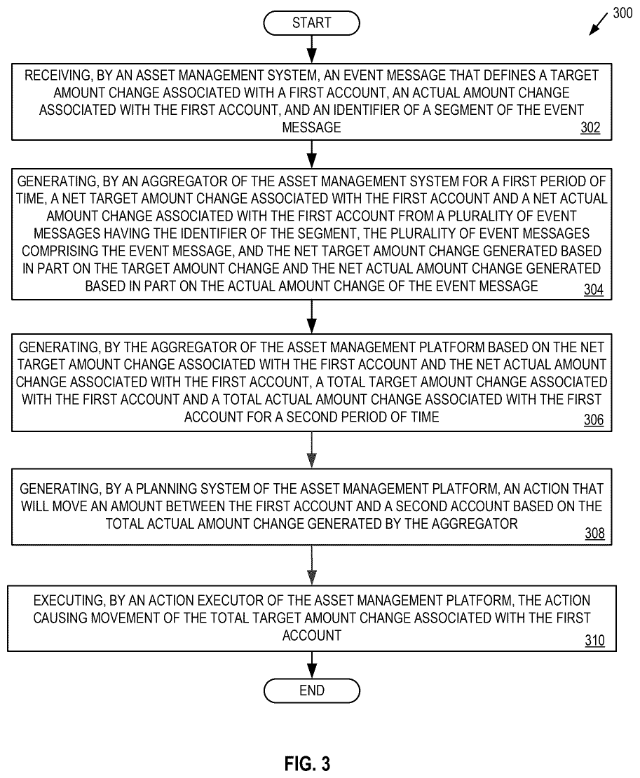

FIG. 3 illustrates a flow diagram 300 of one embodiment of a process for performing asset management by an asset management system. The process is performed by processing logic that may comprise hardware (circuitry, dedicated logic, etc.), software (such as is run on a general-purpose computer system or a dedicated machine), firmware, or a combination. In one embodiment, the process is performed by asset management system 220 or asset management system 420.

The process begins by receiving, by an asset management system, an event message that defines a target amount change associated with a first account, an actual amount change associated with the first account, and an identifier of a segment of the event message (processing block 302). In the embodiment discussed in FIG. 3, the event message is an asset management event message as discussed above. Furthermore, each event message includes a segment identifier, which enables processing logic to map the asset movement defined by the event message to netting groups. Furthermore, each event message additionally defines the accounts associated with a requested asset movement, the target amount change and the actual amount change associated with the accounts, as well as other data associated with a requested asset movement.

Processing logic then generates, by an aggregator of the asset management system for a first period of time, a net target amount change associated with the first account and a net actual amount change associated with the first account from a plurality of event messages having the identifier of the segment, the plurality of event messages comprising the event message, and the net target amount change generated based in part on the target amount change and the net actual amount change generated based in part on the actual amount change of the event message (processing block 304). As discussed herein, the segment identifier in the event message enables processing logic to map the event message to a netting group, and aggregation combines the individual asset movements from the group together. The netting groups may be associated with a single segment identifier or a plurality of segment identifiers. Furthermore, the segment identifier(s) that map to a netting group, are configurable and can change over time. In embodiments, processing logic is updated with reconfigured mappings on a periodic basis, or in response to such mapping configuration changes.

The aggregator executed by processing logic performs aggregation using the event message for a first time period, such as a 1-minute, two-minute, five-minute, etc. period of time. Then, the target amount change and the actual amount change specified in the event message may be combined and/or net against the asset movements requested by other event messages within the netting group over the first time period. In some examples, once combined and/or netted, the individual event messages may be deleted or freed in memory to reduce storage used by the aggregator and the asset management system. Thus, the aggregation operations enhance memory utilization efficiency in the processing of a stream of asset management event messages.

In examples, processing block 304 is repeated until a second time period. For example, where the first time period is a five-minute interval, and the second time period if a fifteen-minute interval, then processing block 304 is repeated 3 times forming three buckets per segment identifier each having net target amount and net actual amount changes for asset movements for the segment over corresponding time periods. Processing logic then generates, by the aggregator of the asset management platform based on the net target amount change associated with the first account and the net actual amount change associated with the first account, a total target amount change associated with the first account and a total actual amount change associated with the first account for a second period of time (processing block 306). In embodiments, the second aggregation operation combines and/or nets the prior segment buckets with one another before execution of actions to realize the asset transfers.

Processing logic generates, by a planning system of the asset management platform, an action that will move an amount between the first account and a second account based on the total actual amount change generated by the aggregator (processing block 308). In some embodiments the planning system may be comprised in a sweeps processor that further nets transfer amounts among netting groups. Furthermore, the planning system uses the timing data within the event messages (e.g., a timing constraint defining when an asset movement is to be available at a destination account), as well as known planning timing data (e.g., time required to process a movement given one or more factors, such as type of asset movement, amount of asset movement, source account, destination account, etc.), to plan a just-in-time sweep. As discussed herein, utilizing such timing information avoids oscillation and reduces network bandwidth by avoiding messaging that moves assets to and from the same account. In embodiments, the planning system will seek to net the differences when available within a segment. For example, Account A has a need/deficit of X, Accounts B and C each have a surplus of X/2, and the accounts belong to the same netting group. Then the planning system, assuming routes and constraints are satisfied as discussed above, performs netting, or in this example zeroing out, the deficit of account A with the surpluses of Accounts B and C. Such netting uses two asset movements during a planning cycle, rather than three with oscillation (e.g., executing each action independently). As a result, asset movement planning resources are saved, and network bandwidth consumption is reduced by reducing the overall amount of messaging used to effectuate asset transfers.

Processing logic executes, by an action executor of the asset management platform, the action causing movement of the total target amount change associated with the first account (processing block 308). In some embodiments, the action executor is a sweeps processing system that performs or generates messages causing performance of physical movement of assets between accounts. Furthermore, in some embodiments, the action executor may emit an asset movement completion event for consumption by an attribution system, where the asset movement completion event is indicative of satisfaction of a received asset management event message's movement request. As discussed above, the physical movements correspond with the resulting netted asset movements per segment, and ensures that liquidity is provided for in each account of the commerce platform at the appropriate time.

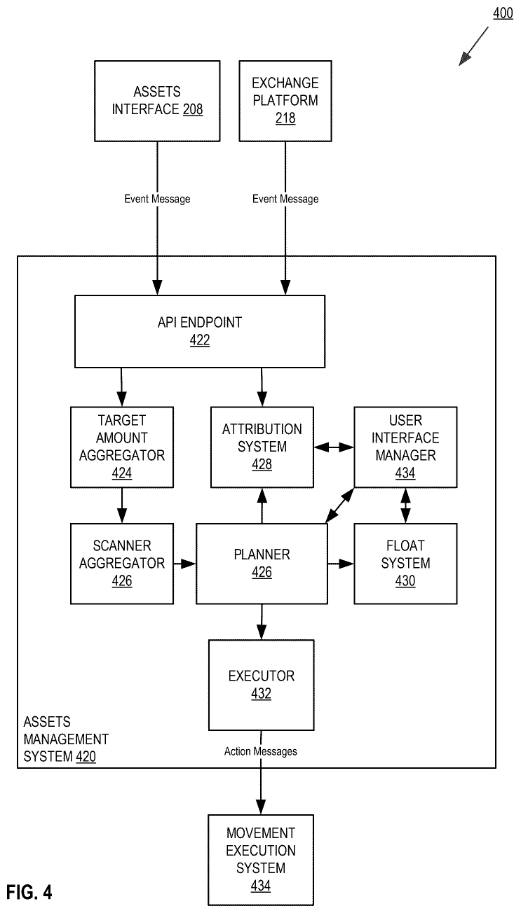

FIG. 4 is a block diagram 400 of an asset management system 420 of a distributed assets management platform. Asset management system 420 provides additional details for the asset management system 220 discussed above in FIG. 2.

Asset management system 420 includes API endpoint 422. API endpoint is exposed to the systems of the distributed assets management platform 200, and in particular to the assets interface 208 and the exchange platform 218. As discussed herein, the API endpoint is configured to receive remote procedure call (RPC) asset management event messages from the assets interface 208 and the exchange platform 218. A plurality of RPC asset management event messages are received by the API endpoint as a stream of event messages. Furthermore, each asset management event message includes at least a segment identifier that maps the event message to a netting group, account identifier(s) identifying accounts assets are to be exchanged between, a target and an actual amount of an asset movement, a timing requirement of each asset movement, as well as other data relevant to an asset movement.

API endpoint 422, upon receiving the event messages provides the event messages to target amount aggregator 424. Target amount aggregator 424 is responsible for partitioning or organizing event messages by segment identifier into netting groups. Netting groups are groups of asset movements that may bet net (e.g., offset) against one another. Furthermore, as discussed herein, a single segment identifier may be associated with a netting group, or a plurality of segment identifiers may be associated with the same netting group. This mapping of segment identifiers to netting groups is configurable, such as for example, by an operator of the assets management system 420. For example, the operator may edit a mapping file stored in a memory of the target amount aggregator 424. As another example, the mapping may be edited via a graphical user interface generated by user interface manager 434.

Target amount aggregator 424 is also responsible for performing aggregation of event messages in each netting group over a first periodic interval. In some examples, the first periodic is less than a second periodic interval used by scanner aggregator 426 as discussed above. Furthermore, the aggregation performed at the first periodic interval is used to form two or more time-based buckets per segment identifier until the second periodic interval. In embodiments, target amount aggregator 424 maintains the events in a memory of the aggregator 424 until the aggregation has occurred, at which point the event messages are deleted and/or memory storing those aggregated messages freed for other uses. In either scenario, the deletion or memory freeing ensures reduced system memory usage by target amount aggregator increasing overall memory usage efficiency of the assets management system 420. Such efficiency gains are increasingly valuable for systems that operate at scale, such as the assets management system 420.

Scanner aggregator 426 accesses the first aggregation results, referred to above as aggregation buckets by segment identifier. Scanner aggregator 426 then aggregates the time-based buckets into a final aggregation result over the second time period, where the second time period includes the set of time buckets per segment identifier into netting group asset movement totals. Furthermore, these netting groups are further constrained by the time requirements which ensure that transfers occur in a timely fashion (e.g., by time requirements of netting groups). The scanner aggregator 426 then provides access to the results to planner 426.

Planner 426 is responsible for performing netting of the asset movement totals for netting groups, and once netted, scheduling any resulting asset transfers between accounts. In embodiments, planner 426 maintains asset movement configurations in the form of allowed routes (e.g., route of Acct_A→Acct_B is allowed for a segment identifier), as well as constraints (e.g., segment X should not transfer money to country Y). The allowed routes and the constraints are configurable, such as through a configuration file, via a configuration graphical user interface of the user interface manager 434, or by other configuration operations. Thus, at the second time period when the scanner aggregator 426 has performed the second set of aggregation operations, planner will seek to net account transfers within each netting group. Additionally, planner 426 uses the timestamps (balance available at data) to plan a just-in time movement. For example, for Accounts A, B, and C all part of the same netting group, Account A has a need/deficit of X as determined by the scanner aggregator 426, and Accounts B and C each have a surplus of X/2 as determined by the scanner aggregator 426. Then the planner, assuming routes and constraints are satisfied, can net or zero out the deficit of account A with the surpluses of Accounts B and C since the accounts and associated events are part of the same segment/netting group. Furthermore, in the example, the netting can occur using two asset movements during a planning cycle, as opposed to more movements that would be performed without netting. This netting performed by planner 426 and using the results of scanner aggregator 426 avoids oscillation by avoiding transferring assets in and out of the same account, and additionally reduces network bandwidth by accounting for as much netting as possible before action execution (e.g., avoiding consuming bandwidth with additional asset transfer messaging). Furthermore, the netting results define the asset movements by segment identifier being the net or final asset movement needs for a given periodic interval. That is, the netting results define the deficits and surpluses for accounts, and the planner configures account transfers to ensure that the deficits and surpluses are resolved.

In some embodiments, and in response to netting per segment, planner 426 may generate a swap event, rather than a sweep event. Whereas sweep events effectuate transfers between accounts, swap events are short term asset movements performed as short term loans. More specifically, if an asset transfer has a need (e.g., a transfer of $X is needed by Acct_A based on aggregation and netting), and an excess exists in an Acct_B in a different currency for a known period of time, then a swap can be generated that exchanges an amount of the excess currency for the needed amount (e.g., exchange $Y from Acct_B to $X). The exchanged currency can be provided to the account with the assets needed until a swap back can occur, such as the account receiving the swap having an excess balance sufficient to return the swapped currency. In embodiments, planner 426 ensures that a swap is allowed (e.g., satisfies constraints and routes), and that the existing surplus will exist for the period of time needed (e.g., Acct_B will have $Y available for 2 days, a transfer from Acct_B→Acct_A is allowed, and Acct_A can return the swapped amount within the 2 day period). In embodiments, such a swap is performed with the aid of exchange platform 218.

Planner emits transfer events to the executor 432, which forms and transmits messages to a movement execution system 434, including emitting asset movement completion event messages. In embodiments, the movement execution system 434 may be the sweeps processor 222 discussed above that performs sweeps or transfers between accounts according to the plans. In embodiments, planner 426 utilizes timing information in transfers to schedule/plan account transfers at the latest time available. That is, timing information for account transfers is known by planner 426 (e.g., available at data, flight time data including time to actually realize the transfer for given accounts, etc.). Planner utilizes this timing information to plan/schedule an event by executor 432 to take actions at the last possible moment, taking fastest trading path, inserting buffers for timing coordination, etc. As discussed above, such just-in-time transfers avoid oscillation (e.g., moving cash back and forth) and reduce an overall number of transfer events (e.g., messaging causing transfers), both of which reduce bandwidth consumed by the planner 426 and executor 432. In other words, by delaying transfers as long as possible, more netting can occur to offset various transfers, and an overall reduction in event messaging traffic is achieved to free up network bandwidth.

Planner 426, in embodiments, generates float data that is sent to float system 430. In embodiments, planner 426 further emits planned transfers to float system 430 for determining float. Float system 430 attributes how much float is being produced or consumed by the planner's 426 scheduled asset movements. Float occurs when an asset is accounted for twice, such as when an actual transfer amount less a target transfer amount is non-zero for a segment key. Such float can be measured by time, source account, and segment key. In embodiments, float system 430 calculates float amounts based on two inputs, a float contribution event generated and emitted by planner 426 when an asset transfer moves a non-zero amount between segment identifiers (e.g., actual asset amount movement-target asset amount movement is not zero). This value represents the float that a given segment is contributing (or taking) from another segment. A balance maintained for a segment key after a planned sweep is also a source of float, which represents float in a given segment. Another measure of float is calculated, for a given combination of time, source bank account, and segment identifier by adding up the float usage by segment identifier and across segments, which float system 430 can aggregate by source bank account and also by segment identifier to get source bank account level float usage and segment level float usage over time. These float usage values, such as by source account and segment over time are calculated after each planned set of actions sent to executor 432. Thus, user interface manager 434 may access the time based float usage data to generate and render float usage graphical user interfaces providing real-time and historical float usage data to user. Such float usage is valuable to ensure proper asset management levels in accounts.

In embodiments, attribution system 428 is an application that monitors or listens to the API endpoint 422 to capture a record of an occurrence of event messages and relevant event message data (e.g., segment identifier, timing constraints, account identifiers, etc.) received by the assets management system. The messages and/or events can include those streaming into assets management system (e.g., via API endpoint), as well as float usage event messages, and asset movement completion event messages. The attribution system 428 application can be, for example, a FLINK application that processes streaming data. Furthermore, attribution system 428 stores the record of the occurrence of event messages in a first in first out (FIFO) ordering in a memory of the attribution system. Attribution system 428 further monitors the events generated by planner 426, such as planned asset movements sent to executor 432. The planned asset movements also include data, such as segment identifiers, account identifiers, asset movement timing constraints, etc. In other words, attribution system monitors and captures event data for all events related to asset transfers that occur in assets management system 420

In embodiments, user interface manager 434 generates and renders an event attribution user interface that enables user requests to attribute underlying asset management events to a set of zero or more individual asset movements. In embodiments, based on segment identification data, account data, and timing data of a selected asset movement (e.g., a sweep planned by planner 426 and caused to be run by executor 432), attribution system 428 attributes asset management events to the asset movement. Although netting has occurred per segment, the FIFO event message storage of attribution system 428 is accessed to extract relevant events (e.g., based on segment identifier, account, and timing information), and the extracted events are traversed until an amount of an account transfer is satisfied. The extracted events are deemed by attribution system 428 to be contributing events to the asset transfer, and may be presented to a requesting user via user interface manager 434. A real-time view of asset management event message contribution to asset transfers is enabled, which provides input into the planning and transfer processes of the assets management system 420.

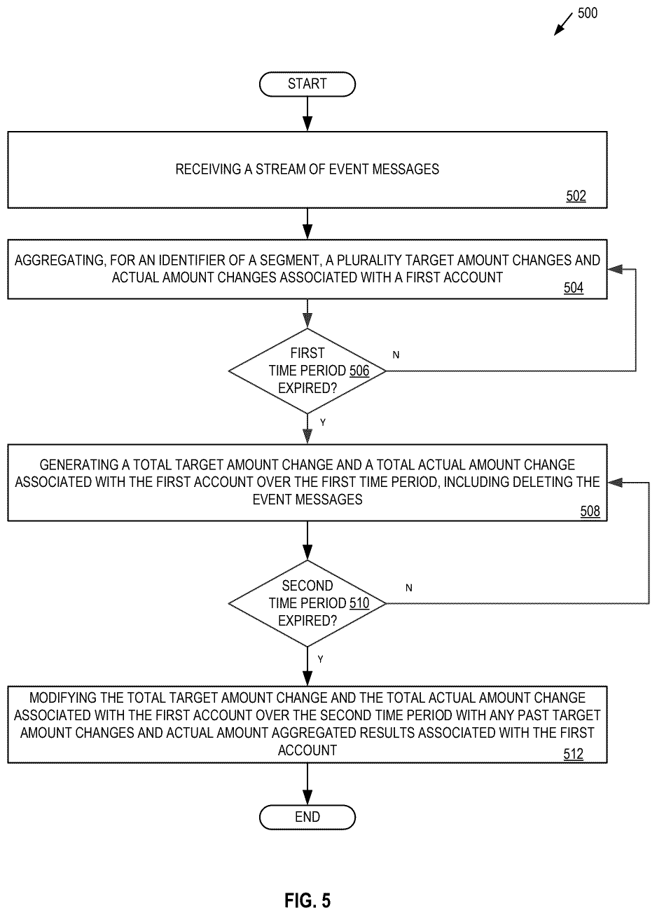

FIG. 5 is a diagram of one embodiment of a process 500 performed by an asset management system for performing sets of aggregation operations. The process is performed by processing logic that may comprise hardware (circuitry, dedicated logic, etc.), software (such as is run on a general-purpose computer system or a dedicated machine), firmware, or a combination. In one embodiment, the process is performed by asset management system 220 or asset management system 420.

The process begins by receiving a stream of event messages (processing block 502). The event messages, as discussed herein, are asset management event messages received at an API endpoint of an assets management system (e.g., system 220 or 420). Furthermore, each message includes at least a segment identifier, asset transfer amounts, and a time requirement. Furthermore, the stream includes a plurality of event messages.

Processing logic aggregates, for an identifier of a segment, a plurality target amount changes and actual amount changes associated with a first account (processing block 504). Processing logic segments event messages by segment identifier and aggregates transfer totals for accounts, including the first account, for the event messages associated with the segment identifier. In embodiments, the segment identifier maps to netting groups, as discussed herein, and thus the aggregation is an aggregation of amounts across a netting group. Furthermore, because there may be more than one netting group, the process performed by processing block 504 may be performed by mapping segment identifier(s) to and performing aggregation for each netting group.

Processing logic then determines if a first time period has expired (processing block 506). If the first time period has not expired, the process returns to processing block 504 to continue aggregation operations. However, if the time period has expired, the process advances to processing block 508.

At processing block 508, processing logic generates a total target amount change and a total actual amount change associated with the first account over the first time period, including deleting the event messages (processing block 508). The total target amount change and the total actual amount change associated with the first account over the first time period represent an aggregation bucket over the first time period. In some embodiments, this may also be referred to as a pre-aggregation total, with final aggregation occurring in processing block 512, discussed below. Furthermore, event messages that contributed to the aggregation bucket can be deleted, or the memory associated with those events otherwise freed, to ensure efficient memory usage by processing logic. In some embodiments, the deletion of event messages occurs at the conclusion of the first time period, and in other embodiments occurs upon an asset management event message being aggregated into an aggregation bucket. That is, while the aggregation totals per segment and time period are retained until final aggregation, and event storage requirements are relieved to free memory. Based on large scale distributed systems, such as that discussed herein, such memory savings and efficiency gains are significant and greatly improve the efficiency and operation of such systems.

Processing logic then determines if a second time period has expired (processing block 510). If the second time period has not expired, the process returns to processing block 508 to continue generation of aggregation buckets over a first periodic intervals, over the second time period. However, if the second time period has expired, the process advances to processing block 512.

Processing logic modifies the total target amount change and the total actual amount change associated with the first account over the second time period with any past target amount changes and actual amount aggregated results associated with the first account (processing block 512). Processing block 512 is a final aggregation stage, where the finality refers to the aggregation of the pre-aggregation buckets to generate final account asset movement data. The final account asset movement data represents liquidity needs of the first account, and is provided to a planner for netting, scheduling, and causing execution of an asset movement.

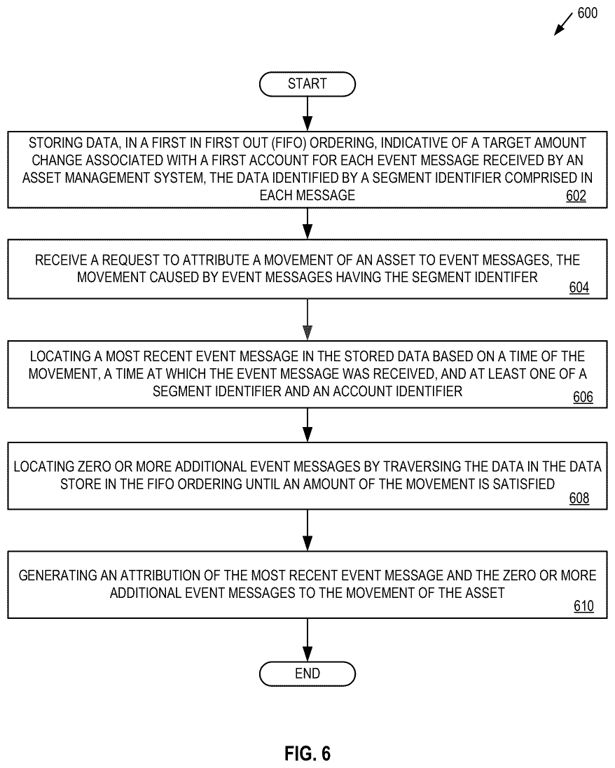

FIG. 6 is a diagram of one embodiment of a process performed by an asset management system for attributing asset movements to event messages. The process is performed by processing logic that may comprise hardware (circuitry, dedicated logic, etc.), software (such as is run on a general-purpose computer system or a dedicated machine), firmware, or a combination. In one embodiment, the process is performed by asset management system 220 or asset management system 420.

Processing logic begins by storing data, in a first in first out (FIFO) ordering, indicative of a target amount change associated with a first account for each event message received by an asset management system, the data identified by a segment identifier comprised in each message (processing block 602). In embodiments, processing logic monitors an interface of an assets management system to listen for and/or intercept asset management event messages streaming to the asset management system. Furthermore, data associated with the asset management event messages, such as segment identifiers, account identifiers, asset movement amounts, asset movement timing requirements, etc. is extracted from each event message. Additionally, other event messages may be detected, such as asset movement completion event messages emitted by a sweeps processor or action executor, as discussed herein. These asset movement completion event messages are indicative of satisfaction of requested movements of one or more asset management event messages. The record of the event messages and their extracted information is then stored in FIFO ordering of an attribution system (e.g., attribution system 428).

Processing logic then receives a request to attribute a movement of an asset to event messages, the movement caused by event messages having the segment identifier (processing block 604). In embodiments, the request is an asset movement attribution request and can be received via a graphical user interface presented to a user. In embodiments, the request specifies an asset movement of interest, from which a timing of the movement is determined. Additional data associated with the asset movement of interest, such as account identifiers, segment identifiers, etc. are also determined.

Processing logic locates a most recent event message in the stored data based on a time of the movement, a time at which the event message was received, and at least one of a segment identifier and an account identifier (processing block 606). In embodiments, the timing information of the event message data stored in the FIFO ordering is accessed based on the time associated with the asset movement, and identifiers (e.g., segment and/or account identifiers), to locate potentially relevant event messages. For example, if an asset movement occurred on DATE at time X, then the last event message before expiration of time X on DATE is selected. That is, this event message, assuming it belongs to a matching segment and/or account, is the last event message in the FIFO store that could have contributed to the asset movement of interest.

Processing logic then locates zero or more additional event messages by traversing the data in the data store in the FIFO ordering until an amount of the movement is satisfied (processing block 608). In embodiments, the FIFO store is traversed until an amount of the transfer is satisfied from the originally located event message data (e.g., the event message identifies at processing block 606), and zero or more additional event messages that would have contributed to the total asset movement of interest.

Processing logic then generates an attribution of the most recent event message and the zero or more additional event messages to the movement of the asset (processing block 610). In some embodiments, the attribution is provided to a requesting user in a graphical user interface detailing the asset movement of interest and listing each event that contributed to the asset movement. The FIFO memory and storage of event messages enables insight into the complex operations of the assets management system. Through this memory configuration and storage technique, a proper attribution of events to a complete asset movement can be determined and presented to a requesting user, improving the overall visibility of the internal operations of the asset management system.

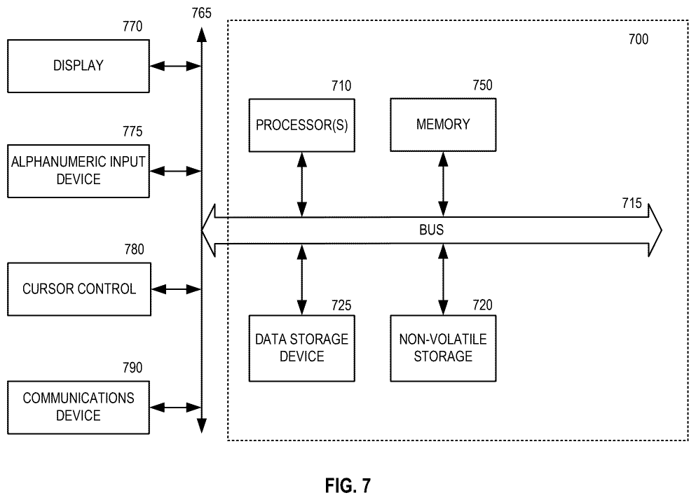

FIG. 7 is one embodiment of a computer system that may be used to support the systems and operations discussed herein. In some examples, the computer system illustrated in FIG. 7 may be used by a commerce platform, a merchant system, user system, third party system, etc. It will be apparent to those of ordinary skill in the art, however that other alternative systems of various system architectures may also be used.

The data processing system illustrated in FIG. 7 includes a bus or other internal communication means 715 for communicating information, and one or more processor(s) 710 coupled to the bus 715 for processing information. The system further comprises a random access memory (RAM) or other volatile storage device 750 (referred to as memory), coupled to bus 715 for storing information and instructions to be executed by processor 710. Main memory 750 also may be used for storing temporary variables or other intermediate information during execution of instructions by processor 710. The system also comprises a read only memory (ROM) and/or static storage device 720 coupled to bus 715 for storing static information and instructions for processor 710, and a data storage device 725 such as a magnetic disk or optical disk and its corresponding disk drive. Data storage device 725 is coupled to bus 715 for storing information and instructions.

The system may further be coupled to a display device 770, such as a light emitting diode (LED) display or a liquid crystal display (LCD) coupled to bus 715 through bus 765 for displaying information to a computer user. An alphanumeric input device 775, including alphanumeric and other keys, may also be coupled to bus 715 through bus 765 for communicating information and command selections to processor 710. An additional user input device is cursor control device 780, such as a touchpad, mouse, a trackball, stylus, or cursor direction keys coupled to bus 715 through bus 765 for communicating direction information and command selections to processor 710, and for controlling cursor movement on display device 770.

Another device, which may optionally be coupled to computer system 700, is a communication device 790 for accessing other nodes of a distributed system via a network. The communication device 790 may include any of a number of commercially available networking peripheral devices such as those used for coupling to an Ethernet, token ring, Internet, or wide area network. The communication device 790 may further be a null-modem connection, or any other mechanism that provides connectivity between the computer system 700 and the outside world. Note that any or all of the components of this system illustrated in FIG. 7 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 750, mass storage device 725, or other storage medium locally or remotely accessible to processor 710.

It will be apparent to those of ordinary skill in the art that the system, method, and process described herein can be implemented as software stored in main memory 750 or read only memory 720 and executed by processor 710. This control logic or software may also be resident on an article of manufacture comprising a computer readable medium having computer readable program code embodied therein and being readable by the mass storage device 725 and for causing the processor 710 to operate in accordance with the methods and teachings herein.

The embodiments discussed herein may also be embodied in a handheld or portable device containing a subset of the computer hardware components described above. In some examples, the handheld device may be configured to contain only the bus 715, the processor 710, and memory 750 and/or 725. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. In some examples, the appliance may include a processor 710, a data storage device 725, a bus 715, and memory 750, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purposes of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

What is claimed is:

1. A method for a distributed services system providing asset management during distributed services execution, comprising:
receiving, by an asset management system, an event message that includes a target amount change associated with a first account, an actual amount change associated with the first account, and an identifier of a segment of the event message;
generating, by an aggregator of the asset management system for a first period of time, a net target amount change associated with the first account and a net actual amount change associated with the first account from a plurality of event messages having the identifier of the segment, the plurality of event messages comprising the event message, and the net target amount change generated based in part on the target amount change and the net actual amount change generated based in part on the actual amount change of the event message;
generating, by the aggregator of the asset management system based on the net target amount change associated with the first account and the net actual amount change associated with the first account, a total target amount change associated with the first account and a total actual amount change associated with the first account for a second period of time;
generating, by a planning system of the asset management platform, an action that will move an amount between the first account and a second account based on the total actual amount change generated by the aggregator; and
executing, by an action executor of the asset management platform, the action causing movement of the total target amount change associated with the first account.

2. The method of claim 1, wherein the first period of time is less than the second period of time.

3. The method of claim 2, further comprising:
deleting, from a memory of the asset management system, the net target amount change associated with the first account and the net actual amount change associated with the first account after generation of the total target amount change associated with the first account and the total actual amount change associated with the first account for the first period of time; and
generating, by the aggregator during the first period of time, a second net target amount change associated with the first account and a second net actual amount change associated with the first account.

4. The method of claim 1, wherein the event message is deleted from a memory of the asset management system after the net target amount change associated with the first account and the net actual amount change associated with the first account are generated by the aggregator.

5. The method of claim 1, wherein the event message comprises an application programming interface (API) event message, and the API event message is received an API endpoint exposed by an interface of the asset management system.

6. The method of claim 1, wherein generating the action that will move an amount between the first account and the second account further comprises:
determining, by the planning system, a first time at which the amount of the first account is to be changed;
determining, by the planning system, a second time that defines a length of time associated with movement of the amount between the first account and the second account; and
generating, by the planning system, the action for execution at a third time determined based on the first time adjusted by the second time.

7. The method of claim 1, further comprising:
maintaining, in a memory of the asset management system, an ordering of event messages received by the asset management system;
receiving, by the asset management system, a request to attribute one or more event messages to the action causing movement of the total target amount change associated with the first account;
accessing a first event message in an order defined by the ordering of event messages to locate a most recent event message that is associated with a movement of an asset to or from the first account; and
accessing a plurality of second event messages based on the order defined by the ordering of event messages until a total number of movements caused by the first event message and the plurality of second event messages equals the total target amount change associated with the first account.

8. The method of claim 1, wherein the amount is associated with a first currency type, the first account has a current balance less than the amount, a third account is associated with a second currency type, the third account has a positive balance, and generating the action comprises:
generating, by the planning system, a first action that swaps a second amount in the second currency type from the third account, to a third amount in the first currency type, the third amount comprising at least a difference between the amount and the current balance of the first account;
generating, by the planning system, a second action causing a temporary movement of the second amount in the first currency type from the third account to the first account; and executing, by the action executor before execution of the action causing movement of the total target amount change associated with the first account, the first action and the second action.

9. A non-transitory machine readable medium may have instructions stored thereon, which when executed by a processing system, causes the processing system to perform operations for a distributed services system providing asset management during distributed services execution, comprising:
receiving, by an asset management system, an event message that includes a target amount change associated with a first account, an actual amount change associated with the first account, and an identifier of a segment of the event message;
generating, by an aggregator of the asset management system for a first period of time, a net target amount change associated with the first account and a net actual amount change associated with the first account from a plurality of event messages having the identifier of the segment, the plurality of event messages comprising the event message, and the net target amount change generated based in part on the target amount change and the net actual amount change generated based in part on the actual amount change of the event message;
generating, by the aggregator of the asset management system based on the net target amount change associated with the first account and the net actual amount change associated with the first account, a total target amount change associated with the first account and a total actual amount change associated with the first account for a second period of time;
generating, by a planning system of the asset management platform, an action that will move an amount between the first account and a second account based on the total actual amount change generated by the aggregator; and
executing, by an action executor of the asset management platform, the action causing movement of the total target amount change associated with the first account.

10. The non-transitory machine readable medium of claim 9, wherein the first period of time is less than the second period of time.

11. The non-transitory machine readable medium of claim 10, further comprising operations for:
deleting, from a memory of the asset management system, the net target amount change associated with the first account and the net actual amount change associated with the first account after generation of the total target amount change associated with the first account and the total actual amount change associated with the first account for the first period of time; and
generating, by the aggregator during the first period of time, a second net target amount change associated with the first account and a second net actual amount change associated with the first account.

12. The non-transitory machine readable medium of claim 9, wherein the event message is deleted from a memory of the asset management system after the net target amount change associated with the first account and the net actual amount change associated with the first account are generated by the aggregator.

13. The non-transitory machine readable medium of claim 9, wherein the operations for generating the action that will move an amount between the first account and the second account further comprise operations for:
determining, by the planning system, a first time at which the amount of the first account is to be changed;
determining, by the planning system, a second time that defines a length of time associated with movement of the amount between the first account and the second account; and
generating, by the planning system, the action for execution at a third time determined based on the first time adjusted by the second time.

14. The non-transitory machine readable medium of claim 9, further comprising operations for:
maintaining, in a memory of the asset management system, an ordering of event messages received by the asset management system;
receiving, by the asset management system, a request to attribute one or more event messages to the action causing movement of the total target amount change associated with the first account;
accessing a first event message in an order defined by the ordering of event messages to locate a most recent event message that is associated with a movement of an asset to or from the first account; and
accessing a plurality of second event messages based on the order defined by the ordering of event messages until a total number of movements caused by the first event message and the plurality of second event messages equals the total target amount change associated with the first account.

15. The non-transitory machine readable medium of claim 9, wherein the second account has a currency type that differs from a currency type of the first account, the second account has a positive balance, and the operations for generating and executing the action further comprise operations for:
generating, by the planning system, a first action causing an asset exchange from assets maintained in the second account to assets of the currency type of the first account;
generating, by the planning system, a second action causing a temporary movement of the assets of the currency type of the first account generated by the first action to the first account; and
executing the first action by transmitting the first action for execution by an exchange platform, and executing the second action by the action executor.

16. A system, comprising:
a non-transitory memory storing instructions; and
a processing system coupled with the memory and configured to execute the instructions causing the system to perform operations, the operations comprising:
receiving, by an asset management system, an event message that includes a target amount change associated with a first account, an actual amount change associated with the first account, and an identifier of a segment of the event message;
generating, by an aggregator of the asset management system for a first period of time, a net target amount change associated with the first account and a net actual amount change associated with the first account from a plurality of event messages having the identifier of the segment, the plurality of event messages comprising the event message, and the net target amount change generated based in part on the target amount change and the net actual amount change generated based in part on the actual amount change of the event message;
generating, by the aggregator of the asset management system based on the net target amount change associated with the first account and the net actual amount change associated with the first account, a total target amount change associated with the first account and a total actual amount change associated with the first account for a second period of time;
generating, by a planning system of the asset management platform, an action that will move an amount between the first account and a second account based on the total actual amount change generated by the aggregator; and
executing, by an action executor of the asset management platform, the action causing movement of the total target amount change associated with the first account.

17. The system of claim 16, wherein the first period of time is less than the second period of time, and the operations further comprise:
deleting, from a memory of the asset management system, the net target amount change associated with the first account and the net actual amount change associated with the first account after generation of the total target amount change associated with the first account and the total actual amount change associated with the first account for the first period of time; and
generating, by the aggregator during the first period of time, a second net target amount change associated with the first account and a second net actual amount change associated with the first account.

18. The system of claim 16, wherein the event message is deleted from a memory of the asset management system after the net target amount change associated with the first account and the net actual amount change associated with the first account are generated by the aggregator.

19. The system of claim 16, wherein the operations for generating the action that will move an amount between the first account and the second account further comprise operations for:
determining, by the planning system, a first time at which the amount of the first account is to be changed;
determining, by the planning system, a second time that defines a length of time associated with movement of the amount between the first account and the second account; and
generating, by the planning system, the action for execution at a third time determined based on the first time adjusted by the second time.

20. The system of claim 16, further comprising operations for:
maintaining, in a memory of the asset management system, an ordering of event messages received by the asset management system;
receiving, by the asset management system, a request to attribute one or more event messages to the action causing movement of the total target amount change associated with the first account;
accessing a first event message in an order defined by the ordering of event messages to locate a most recent event message that is associated with a movement of an asset to or from the first account; and
accessing a plurality of second event messages based on the order defined by the ordering of event messages until a total number of movements caused by the first event message and the plurality of second event messages equals the total target amount change associated with the first account.
